(19) United States
(12) Patent Application Publication
(10) Pub. No.: US 2026/0310204 A1
(43) Pub. Date: Oct. 8, 2026

(54) SYSTEMS AND METHODS FOR MAP ALIGNMENT FOR AUTONOMOUS MOBILE SYSTEM NAVIGATION

(71) Applicant: ROCKWELL AUTOMATION CANADA LTD., Cambridge (CA)

(72) Inventors: Enrique FERNÁNDEZ PERDOMO, Girona (ES); Nolan LUNSCHER, Kitchener (CA); Marco PICCINELLI, Kitchener (CA); Rebecca REDKA, Brantford (CA); Robert BRADFORD, Ajax (CA); Ryan Christopher GARIEPY, Waterloo (CA)

(21) Appl. No.: 19/170,608

(22) Filed: Apr. 4, 2025

(51) Int. Cl. G05D 1/246; G05D 1/224; G05D 109/10

(52) U.S. Cl. CPC G05D 1/2462; G05D 1/2246; G05D 2109/10

(57) ABSTRACT

A method for automatically aligning a source electronic map with a target electronic map to facilitate navigation and localization by one or more autonomous mobile systems within an environment is described. The method comprises: determining a plurality of reference point sets, each reference point set comprising a first reference point being associated with a feature within the source electronic map and a second reference point being associated with the feature within the target electronic map; automatically generating an aligned electronic map by aligning the target electronic map with the source electronic map based on the plurality of reference point sets; evaluating the aligned electronic map to identify any one or more alignment errors exceeding an error threshold; and in response to determining an alignment error exceeds the error threshold, initiating further analysis of the source electronic map and the target electronic map to improve alignment.

### FIELD

The present disclosures relate to map alignment, specifically, the alignment of maps based on common reference points for use in the navigation and localization of autonomous mobile systems.

### INTRODUCTION

Autonomous mobile systems (AMSs), such as robots, autonomous vehicles, and self-driving material transport vehicles, may be used in industrial settings to perform various tasks, such as transporting materials and people around the facility. In order to navigate around the facilities, autonomous mobile systems may use representations of their environment, referred to as maps, to plan routes and avoid obstacles.

Multiple fleets of autonomous mobile systems can often be used in the same environment. For example, if an autonomous mobile system fleet or a building is very large, it may be suitable to divide the fleet into two fleets or more due to technical or operational considerations. Additionally, an environment may utilize multiple models of autonomous mobile systems from different vendors, which operate on their own individual systems.

Each fleet may use their own map representation for the environment they operate in, which may differ from a map representation used by another fleet of vehicles.

### SUMMARY

The various embodiments described herein generally relate to systems and methods for map alignment for autonomous mobile system navigation and localization.

In a broad aspect, in accordance with one or more embodiments, there is generally provided a method for automatically aligning a source electronic map with a target electronic map different from the source electronic map to facilitate navigation and localization by one or more autonomous mobile systems within an environment. The method comprises determining a plurality of reference point sets, each reference point set comprising a first reference point being associated with a feature within the source electronic map and a second reference point being associated with the feature within the target electronic map; automatically generating an aligned electronic map by aligning the target electronic map with the source electronic map based on the plurality of reference point sets; evaluating the aligned electronic map to identify any one or more alignment errors exceeding an error threshold; and in response to determining an alignment error exceeds the error threshold, initiating further analysis of the source electronic map and the target electronic map to improve alignment, otherwise, storing the aligned electronic map for use in operating the one or more autonomous mobile systems.

In some embodiments, the automatically generating an aligned electronic map by aligning the target electronic map with the source electronic map based on the plurality of reference point sets further comprises: determining a first transformation for the target electronic map based on one or more of the plurality of the reference point sets; and generating the first aligned electronic map from the target map based on the first transformation.

In some embodiments, the initiating further analysis of the source electronic map and the target electronic map to improve alignment comprises: determining a plurality of refinement reference point sets; determining a second transformation for the target electronic map based on the plurality of reference point sets and the plurality of refinement reference point sets, wherein the second transformation comprises a non-linear transformation; and generating a second aligned electronic map from the aligned electronic map based on the second transformation.

In some embodiments, the generating the second aligned electronic map based on the second transformation comprises: determining, at the processor, a plurality of weights from the plurality of reference point sets; and generating, at the processor, a weighted average transformation based on the plurality of weights, wherein the plurality of weights are determined based on a proximity to the plurality of reference point sets.

In some embodiments, the establishing the plurality of reference point sets comprises: automatically detecting, at the processor, one or more first identifying features in the first map and one or more second identifying features in the second map; and matching, at the processor, the one or more first identifying features to the one or more second identifying features.

In some embodiments, the determining the plurality of reference point pairs comprises: presenting, at a user interface, a visualization of the first map and the second map to a user; and receiving, at the processor, one or more user inputs specifying a plurality of first input reference points on the first map and a plurality of second input reference points on the second map.

In some embodiments, the evaluating the aligned electronic map comprises determining an image similarity metric comparing at least one probability-based value between the maps.

In some embodiments, the method further comprises transferring, at the processor, one or more semantic information from between the source map and the target map based on the aligned map.

In some embodiments, the source map is produced using a first sensing modality and the target map is produced using a second sensing modality, the first sensing modality being different from the second sensing modality.

In some embodiments, the determining that an alignment error exceeds an error threshold comprises determining that the alignment error exceeds an error threshold for a particular region of the aligned electronic map, and wherein the plurality of refinement reference point sets is located in the particular region.

In another broad aspect, in accordance with one or more embodiments, there is generally provided a system for aligning a source electronic map with a target electronic map different from the source electronic map to facilitate navigation and localization by one or more autonomous mobile systems within an environment. The system comprises: a processor, configured to: determine a plurality of reference point sets, each reference point set comprising a first reference point being associated with a feature within the source electronic map and a second reference point being associated with the feature within the target electronic map; automatically generate an aligned electronic map by aligning the target electronic map with the source electronic map based on the plurality of reference point sets; evaluate the aligned electronic map to identify any one or more alignment errors exceeding an error threshold; and in response to determining an alignment error exceeds the error threshold, initiate further analysis of the source electronic map and the target electronic map to improve alignment, otherwise, storing the aligned electronic map for use in operating the one or more autonomous mobile systems.

In some embodiments, the processor automatically generates an aligned electronic map by aligning the target electronic map with the source electronic map based on the plurality of reference point sets by: determining a first transformation for the target electronic map based on one or more of the plurality of the reference point sets; and generating the first aligned electronic map from the target map based on the first transformation.

In some embodiments, the processor initiates further analysis of the source electronic map and the target electronic map to improve alignment by: determining a plurality of refinement reference point sets; determining a second transformation for the target electronic map based on the plurality of reference point sets and the plurality of refinement reference point sets, wherein the second transformation comprises a non-linear transformation; and generating a second aligned electronic map from the aligned electronic map based on the second transformation.

In some embodiments, the processor generates the second aligned electronic map based on the second transformation by: determining, at the processor, a plurality of weights from the plurality of reference point sets; and generating, at the processor, a weighted average transformation based on the plurality of weights, wherein the plurality of weights are determined based on a proximity to the plurality of reference point sets.

In some embodiments, the processor establishes the plurality of reference point sets by: automatically detecting, at the processor, one or more first identifying features in the first map and one or more second identifying features in the second map; and matching, at the processor, the one or more first identifying features to the one or more second identifying features.

In some embodiments, the processor determines the plurality of reference point pairs by: presenting, at a user interface, a visualization of the first map and the second map to a user; and receiving, at the processor, one or more user inputs specifying a plurality of first input reference points on the first map and a plurality of second input reference points on the second map.

In some embodiments, the processor evaluates the aligned electronic map by determining an image similarity metric comparing at least one probability-based value between the maps.

In some embodiments, the processor is further configured to transfer one or more semantic information from between the source map and the target map based on the aligned map.

In some embodiments, the source map is produced using a first sensing modality and the target map is produced using a second sensing modality, the first sensing modality being different from the second sensing modality.

In some embodiments, the processor determines that an alignment error exceeds an error threshold by determining that the alignment error exceeds an error threshold for a particular region of the aligned electronic map, and the plurality of refinement reference point sets is located in the particular region.

### DRAWINGS

Several embodiments will now be described in detail with reference to the drawings, in which:

FIG. 1 is a block diagram of an example scenario in which a system for map alignment may be used.

FIG. 2 is a block diagram of another example scenario in which a system for map alignment may be used.

FIG. 3 is a block diagram of an example system for map alignment.

FIG. 4 is a block diagram of an example computer device.

FIG. 5 is a flowchart of an example method for map alignment.

FIGS. 6a and 6b are example maps to be aligned.

FIG. 6c is an example aligned map corresponding to the maps of FIGS. 6a and 6b.

FIGS. 7a, 7b, 7c, 7d, and 7e show example source and target maps for alignment in various stages of the alignment process.

FIGS. 8a and 8b are example maps to be aligned.

FIG. 8c is an example aligned map corresponding to the maps of FIGS. 8a and 8b.

FIG. 9 show example facilities connected by an outdoor path.

FIG. 10 is a block diagram of example autonomous mobile systems in communication with an example system data storage.

FIG. 11 is a block diagram of an example autonomous mobile system.

FIG. 12 is another block diagram of an example autonomous mobile system.

### DESCRIPTION OF VARIOUS EMBODIMENTS

Autonomous mobile systems may create maps for environments they may operate in. A map may be any representation of the environment that contains models of the free and occupied space within the environment. Maps can also include salient features in the environment, such as fiducial markers like QR codes, that can be used as landmarks to keep autonomous mobile systems localized within the map. Maps define references frames to localize the AMS within the map, as well as other autonomous mobile systems and environmental objects present in the same environment. The environmental objects may include objects for interaction with the AMS, such as docking targets.

Some environments may use multiple fleets of AMS rather than just one single fleet. For example, AMS fleets may be divided based on organizational structure, where different departments or zones can control their own autonomous mobile systems. Additionally, different autonomous mobile systems in different areas may have differing priorities (e.g., manufacturing vs shipping) and may need to be controlled in different ways. Different autonomous mobile systems may be used from different vendors to perform different tasks. For example, one fleet of robots can be deployed to patrol around the facility for security purposes, while another fleet may be used for cleaning. As another example, a fleet can be size constrained due to technical limitations. For instance, there may be a limit to how many robots can communicate with one another under a single central fleet management system due to network bandwidth constraints or computational constraints. Additionally, there can be benefits to dividing a fleet into units of smaller fleets. For instance, a fleet assigned to a smaller area can use smaller maps, which can take up less resources to store, simplify visualization, and simplifier computing.

In larger environments using multiple fleets of autonomous mobile systems, each fleet typically uses its own map representation of the environment it operates in. As such, the pose of an autonomous mobile system in one fleet within an environment may be reported with respect to a different reference frame from an autonomous mobile system in another fleet.

Map alignment is the process of finding a transformation that results in the alignment of one map to another. The map alignment transformation can be used to transform the pose of one autonomous mobile system in one reference frame of one map to another reference frame in another map, or to a common reference frame that can be shared by all autonomous mobile systems in an environment. This may be beneficial to allow autonomous mobile systems using different maps to share their locations with each other, allowing autonomous mobile systems to account for the presence of other autonomous mobile systems in the environment. The transformation can be linear or nonlinear.

Existing systems currently do not adequately perform such translations. For example, fleets of autonomous mobile systems typically only operate using their own map, and therefore their own reference frame, and do not share their poses or positions with autonomous mobile systems of a different fleet. Additionally, current map alignment tools for aligning maps for such purposes typically only support the use of a single global rigid transformation between two maps. As such, it is assumed that the maps to be aligned are consistent and accurate in all areas and contain little to no distortion in comparison to each other. Such tools also typically deal with indoor maps, which are commonly represented as planar occupancy grid formats, and may not support maps of various other formats.

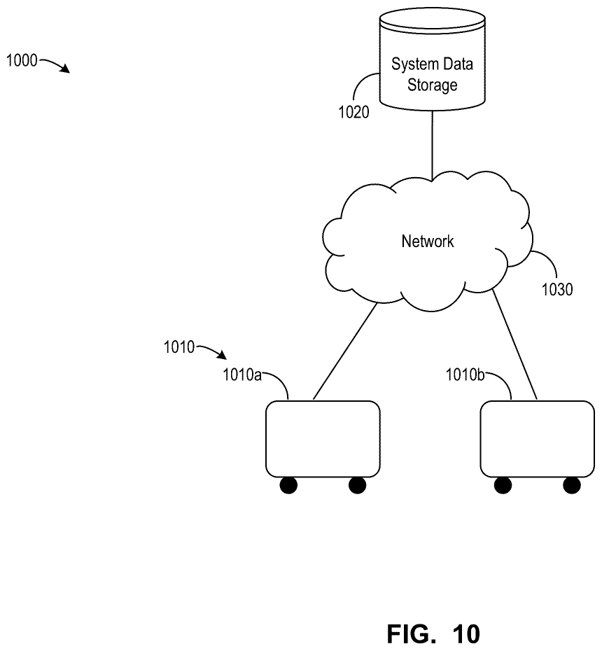

Reference is first made to FIG. 10, which shows a block diagram 1000 illustrating example autonomous mobile systems 1010a, 1010b (collectively referred to as the autonomous mobile systems 1010) in communication with an example storage data system 1020 via a network 1030. While FIG. 10 shows examples of autonomous mobile systems 1010a, 1010b for illustrative purposes, fewer or more autonomous mobile systems 1010 can operate with the system data storage 1020.

The storage data system 1020 can store data related to the autonomous mobile systems 1010. The system data storage can include RAM, ROM, one or more hard drives, one or more flash drives or some other suitable data storage elements such as disk drives, etc. For example, the system data storage 1020 can store electronic maps related to the operating environment of the autonomous mobile systems 1010. The electronic maps located on the system data storage 1020 can be accessible for download, via the network, by the autonomous mobile 1010. The system data storage 1020 can be a part of one or more fleet management systems for controlling and instructing autonomous mobile system 1010

The network 1030 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the autonomous mobile systems 1010, and the system data storage 1020. In some embodiments, the autonomous mobile systems 1010 can communicate with each other via the network 1030. In some embodiments, autonomous mobile system 1010a can communicate with autonomous mobile system 1010b directly via onboard communication components.

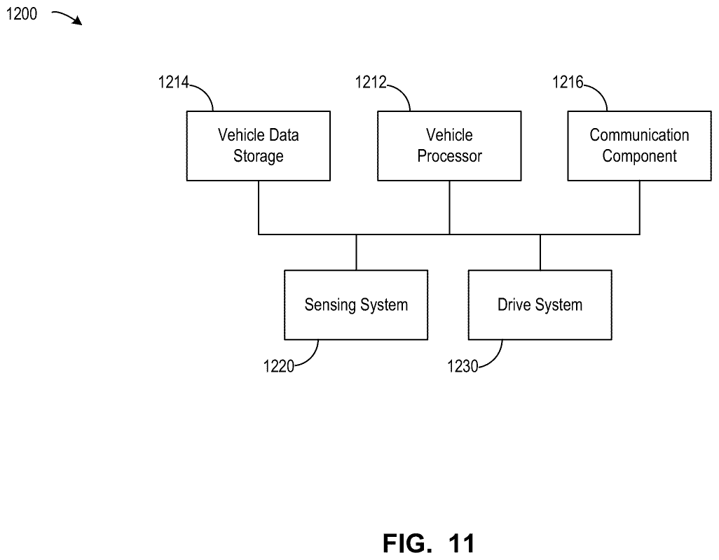

Reference is now made to FIG. 11, which illustrates a block diagram of an example autonomous mobile system 1200 in accordance with one or more embodiments. The autonomous mobile system 1200 can be, for example, a self-driving vehicle. The autonomous mobile system 1200 can include a vehicle processor 1212, a vehicle data storage 1214, a communication component 1216, a sensing system 1220, and a drive system 1230. Components 1212, 1214, 1216, 1220, and 1230 are illustrated separately in FIG. 11, for ease of exposition. In some embodiments, one or more of the components 1212, 1214, 1216, 1220, and 1230 can be combined into fewer components, or separated into further components. In some embodiments, parts of a component can be combined with another part of another component.

The vehicle processor 1212 can include any suitable processor, controller or digital signal processor that can provide sufficient processing power depending on the configuration, purposes and requirements of the autonomous mobile system. In some embodiments, the processor 1212 can include more than one processor with each processor being configured to perform different dedicated tasks.

The vehicle processor 1212 can operate the vehicle data storage 1214, the communication component 1216, the sensing system 1220, and the drive system 1230. For example, the vehicle processor 1212 can operate the sensing system 1220 to determine an initial center of gravity of the autonomous mobile system. The vehicle processor 1212 can also control the vehicle data storage 1214, the communication component 1216, the sensing system 1220, and the drive system 1230, as necessary. The operation of the vehicle processor 1212 can be based on data collected from the vehicle data storage 1214, the communication component 1216, the sensing system 1220, and/or the drive system 1230, in some embodiments.

The vehicle data storage 1214 can include RAM, ROM, one or more hard drives, one or more flash drives, or some other suitable data storage elements such as disk drives, etc. For example, the vehicle data storage 1214 can include volatile and non-volatile memory. Non-volatile memory can store computer programs consisting of computer-executable instructions, which can be loaded into the volatile memory for execution by the vehicle processor 1212. Operating the vehicle processor 1212 to carry out a function can involve executing instructions (e.g., a software program) that can be stored in the vehicle data storage 1214 and/or transmitting or receiving inputs and outputs via the communication component 1216. The vehicle data storage 1214 can also store data input to, or output from, the vehicle processor 1212, which can result from the course of executing the computer-executable instructions for example.

In some embodiments, the vehicle data storage 1214 can store data related to the operation of the autonomous mobile system, such as one or more electronic maps of its operating environment and/or operating parameters. The vehicle data storage 1214 can store data tables, data processing algorithms (e.g., image processing algorithms), as well as other data and/or operating instructions which can be used by the vehicle processor 1212.

The communication component 1216 can include any interface that enables the autonomous mobile system to communicate with other components, and external devices and systems. In some embodiments, the communication component 1216 can include at least one of a serial port, a parallel port or a USB port. The communication component 1216 may also include a wireless transmitter, receiver, or transceiver for communicating with a wireless communications network (e.g. using an IEEE 802.11 protocol or similar). The wireless communications network can include at least one of an Internet, Local Area Network (LAN), Ethernet, Firewire, modem or digital subscriber line connection. Various combinations of these elements may be incorporated within the communication component 1216. For example, the communication component 1216 may receive input from various input devices, such as a mouse, a keyboard, a touch screen, a thumbwheel, a track-pad, a track-ball, a card-reader, voice recognition software and the like depending on the requirements and implementation of the autonomous mobile system.

The communication component 1216 can receive information about obstacles and/or unexpected objects located in the autonomous mobile system's operating environment directly from other autonomous mobile systems within the same operating environment. The vehicle processor 1212 may also transmit, via the communication component 1216, information about obstacles and/or unexpected objects located within the autonomous mobile system's operating environment to other autonomous mobile systems within the same operating environment.

The sensing system 1220 can monitor the environment of the autonomous mobile system 1200. The sensing system 1220 can include one or more sensors for capturing information related to the environment. The information captured by the sensing system 1220 can be applied for various purposes, such as, but not limited to, localization, navigation and/mapping. For example, the sensing system 1220 can include, but not limited to, optical sensors equipped with depth perception capabilities, infrared (IR) capabilities, or sonar capabilities. The optical sensors can include imaging sensors (e.g., photographic and/or video cameras), and range-finding sensors (e.g., time of flight sensors, Light Detection and Ranging (LiDAR) devices which generate and detect reflections of pulsed laser from objects proximal to the autonomous mobile system, etc.). The sensing system 1220 can also include navigational sensors, such as ground positioning system (GPS) sensors, as well as sensors that detect guiding infrastructure installed within the operating environment. Example sensors that detect guiding infrastructure can include, but not limited to, magnetic sensors that detect magnetic tape within a facility warehouse, and/or optical sensors that detect visual navigational indicators within the operating environment, such as fiducial markers. Other example sensors can include an inertial measurement unit (IMU), a 3D or 2D sensor for detecting the roll of the floor, or a linear sensor underneath the autonomous mobile system to measure the autonomous mobile system's distance to the ground. Sensing system 1220 can additionally include global positioning system (GPS) hardware and software.

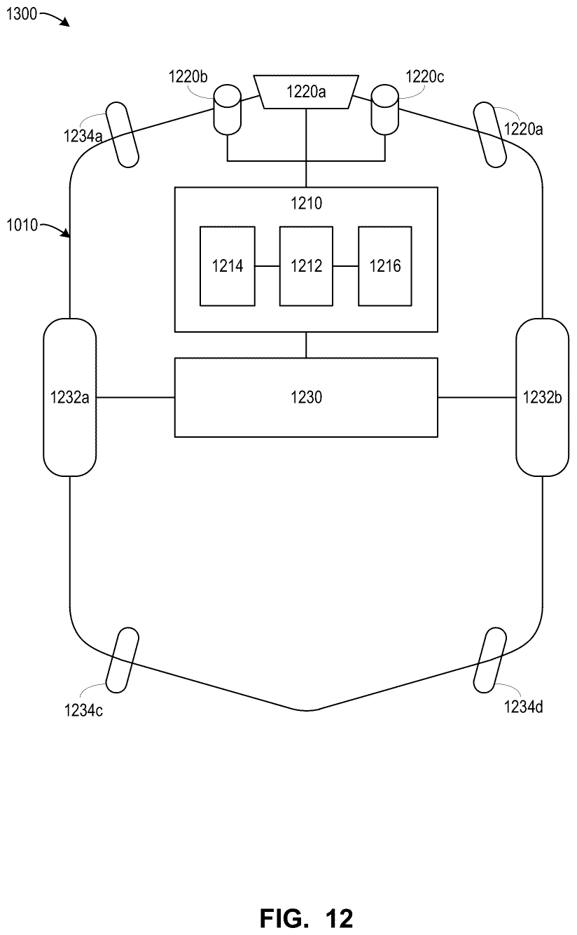

The sensing system 1220 can also include one or more sensors for monitoring the various components and subcomponents of the autonomous mobile system. In some embodiments, the sensing system can monitor the vehicle control system 1210 (FIG. 12), the drive system 1230, and/or subcomponents thereof. For example, the sensing system 1220 may include, but is not limited to, sensors for measuring voltage, current, velocity, acceleration, and/or temperature.

In some embodiments, the sensing system 1220 can include a sensing processor that receives data collected by the sensors and processes the collected data. The sensing processor can operate independently from the vehicle processor 1212. In some other embodiments, the sensing system 1220 can receive the data collected by sensors and transmit the collected data to the vehicle processor 1212 for further processing.

The vehicle processor 1212 can receive the data collected by the sensing system 1220 and can apply the collected data to assist with navigating the autonomous mobile system within its operating environment. For example, the vehicle processor 1212 can receive environment data from the sensing system 1220 in respect of the environment (e.g., a landmark or a fiducial marker) and can cross-reference the received environment data against the electronic map to assist with localizing the autonomous mobile system and to navigate the autonomous mobile system accordingly. The vehicle processor 1212 can, in some embodiments, also use data collected by the sensing system 1220 to determine locations for load pick-up and drop-off. For example, the sensing system 1220 can collect data related to visual markers associated with pick-up and drop-off locations. The sensing system 1220 can then transmit the collected data to the vehicle processor 1212 for processing or can determine the associated location before transmitting the location data to the vehicle processor 1212. Example visual indicators can include, but not limited to, corner tape or graphic patterns placed on the ground for identifying the pick-up or drop-off location. In some examples, the sensing system 1220 can include optical sensors and/or LiDAR sensors operable for detecting the visual indicators.

The sensing system 1220 can also assist the vehicle processor 1212 with executing action commands. For example, when executing an action command corresponding to a load pick-up, the sensing system 1220 can operate to collect image data related to the environment of the autonomous mobile system to assist the vehicle processor 1212 with identifying the load and orienting with respect to the load for the pick-up.

In some embodiments, the sensing system 220 can be operated to monitor the operating environment of the autonomous mobile system for the purpose of minimizing and/or avoiding collisions. The sensing system 220 can also be operated to monitor the center of gravity of the autonomous mobile system and determine when the center of gravity of the autonomous mobile system fails to satisfy a stable operating condition.

The sensing system 1220 can include sensors dedicated for collision avoidance, in some embodiments, or can use existing sensors within the sensing system 220 for collision avoidance. In contrast with sensor data required for localization, navigation and/or mapping, the sensor data required for collision avoidance can be lower resolution. For example, sensors such as LiDAR devices and time-of-flight sensors can generate robust signals that can be quickly transmitted and processed, which can be important for collision avoidance. In some embodiments, the vehicle processor 1212 can use the data collected from the sensing system 1220 for avoidance detection, even though the sensor data may be higher-resolution and requires more processing time.

The vehicle processor 1212 can operate the sensing system 220 to detect an obstacle within the operating environment. In response to detecting the obstacle, the vehicle processor 1212 can implement a collision avoidance operation to minimize, or prevent, a collision between the autonomous mobile system and the detected obstacle. Examples of collision avoidance operations can include, but are not limited to, controlling the drive system 1230 to immediately stop the autonomous mobile system, cutting the power to the vehicle motor, or avoidance steering.

The sensing system 1220 can also include the sensing processor in some embodiments, to assist with collision avoidance. For example, the sensing processor can receive data collected by the sensors to determine whether a collision is imminent and operate one or more collision avoidance operations. The sensing processor can include a low-level processor, such as a programmable logic controller (PLC). The sensing processor can receive, and process low-level signals generated by the sensors, and in turn, can transmit low-level output logic signals to control the drive system 1230 to implement a collision avoidance operation. With a low-level processor, the time required for detecting the collision can be improved to facilitate quick responses (in contrast to the vehicle processor 1212, which is a more complex processor as it needs to execute instructions related to autonomous navigation and other operations).

The drive system 1230 can include the components required for steering and driving the autonomous mobile system 1010. For example, the drive system can include a steering component and a drive motor.

Reference will now be made to FIG. 12, which is another block diagram 1300 of an example autonomous mobile system 1010 in accordance with one or more embodiments. For example, the autonomous mobile system 1010 can be a self-driving vehicle. The autonomous mobile system 1010 can include the vehicle control system 1210, the sensing system 1220, and the drive system 1230.

The drive system 1230 can include a motor and/or brakes connected to drive wheels 1232a and 1232b for driving the autonomous mobile system 1010. According to some embodiments, the motor may be an electric motor, a combustion engine, or a combination/hybrid thereof. In some embodiments, the drive system can include a battery system for powering the motor. Depending on the particular embodiment, the drive system 1230 may include control interfaces that can be used for controlling the drive system 1230. For example, the drive system 1230 may be controlled to drive the drive wheel 1232a at a different speed than the drive wheel 1232b in order to turn the autonomous mobile system 1010. Different embodiments may use different numbers of drive wheels, such as two, three, four, etc.

The drive system 1230 can also include additional wheels 1234a, 1234b, 1234c, and 1234d (collectively referred to herein as wheels 1234). Any or all of the additional wheels 1234 may be wheels that are capable of allowing the autonomous mobile system 1010 to turn, such as castors, omni-directional wheels, and mecanum wheels.

The sensing system 1220 can include a sensor 1220a for detecting obstacles and optical sensors 1220bp, 1220c. Example sensors 1220a for detecting obstacles can include Lidar devices or time-of-flight sensors. As shown in FIG. 12, the sensor 1220a can be located at the front-end of the autonomous mobile system 1010. At this location, the sensor 220a can scan for objects that may enter the path of the autonomous mobile system 1010. More sensors 1220a can be mounted to the autonomous mobile system 1010, in some embodiments. The sensors 1220a can be mounted to different locations, such as the front corner of the autonomous mobile system 1010. Optical sensors 1220b, 1220c can include imaging and/or video cameras, mounted to a forward portion of the autonomous mobile system 1010. According to some embodiments, the sensing system can include optical sensors arranged in manner to provide three-dimensional (e.g. binocular or RGB-D) imaging.

The vehicle control system 1210 can operate the drive system 1230 and the sensing system 1220 and can control and receive information from these components.

The positions of components 1210, 1212, 1214, 1216, 1220, 1230, 1232, and 1234 of the autonomous mobile system 1010 are shown for illustrative purposes and are not limited to the shown positions. Other configuration of the components 1210, 1212, 1214, 1216, 1220, 1230, 1232 and 1234 are possible.

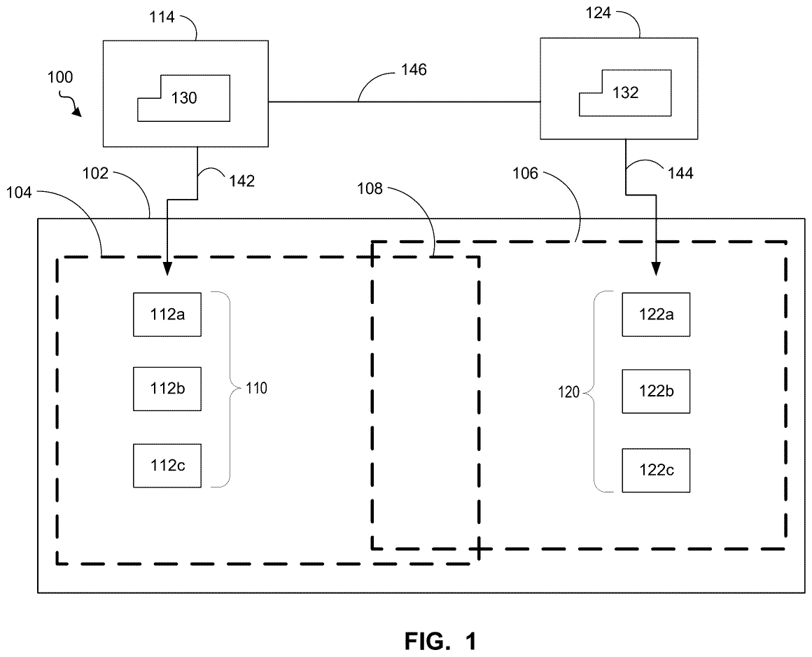

Reference is next made to FIG. 1, which shows an example scenario 100 in which system and methods for map alignment can be used. Scenario 100 includes a facility 102 may utilize at least two fleets of autonomous mobile systems to perform tasks such as, for example, transporting materials around the facility. The autonomous mobile systems can be, for example, the autonomous mobile systems 1010 as shown in FIGS. 10, 11, and 12. Facility 102 can be any facility that may use multiple fleets of autonomous mobile systems. For example, facility 102 can be a large-sized industrial facility such as a warehouse or manufacturing facility that requires multiple fleets of autonomous mobile systems.

A first fleet 110 used in facility 102 includes one or more autonomous mobile systems 112. First fleet 110 may be in communication with a first fleet management system 114, which may control the operations of the autonomous mobile systems 112. For example, first fleet management system 114 may communicate with the autonomous mobile systems 112 through a communication link 142 to instruct the autonomous mobile systems 112 to perform various actions at various locations within the facility 102, to monitor the status of the autonomous mobile systems 112, and monitor the location of autonomous mobile systems 112. Communication link 142 can be wired or wireless. For example, autonomous mobile system 112 and fleet management system 114 may be configured to send and receive signals containing data to be communicated to one another in accordance with a standard or proprietary protocol. Autonomous mobile system 112 may operate in accordance with instructions received from fleet management system 114. For example, upon receiving instructions to perform an action at a target location in environment 100 from fleet management system 114, an autonomous mobile system 112 may plan a path and move to the target location using one or more maps 130 of facility 102. In some embodiments, fleet management system 114 can include the system data storage 1020 of FIG. 10, and may operate to store data relating to the autonomous mobile systems 112.

Fleet management system 114 may assist the navigation of autonomous mobile systems 112 around facility 102. For example, fleet management system 114 may track the locations of autonomous mobile systems 112 and report the location of some autonomous mobile systems to other autonomous mobile systems. For example, system 114 may report the location of autonomous mobile system 112a to autonomous mobile system 112b in order to allow autonomous mobile system 112b to plan a route that avoids autonomous mobile system 112a or an intended trajectory of system 112a.

A second fleet 120 used in facility 102 includes one or more autonomous mobile systems 122. Second fleet 120 may be in communication with a fleet management system 114, which may operate analogously to fleet management system 114 to control the operations of autonomous mobile systems 122.

The fleet management systems 114, 124 can maintain one or more maps 130, 132 used by autonomous mobile systems 112, 122 for navigation around facility 102. Maps 130, 132 can include any structured representation of an environment in which the autonomous mobile system operates. For example, maps 130, 132 can include occupancy grid maps (OGMs), point cloud maps, feature based maps, topological maps, and any other suitable type of map representation as would be known to a person of skill in the art, including hybrid maps that contain one or more types of map data.

The autonomous mobile systems 112, 122 can be equipped with one or more sensors for sensing its surrounding environment. The autonomous mobile systems may use the sensors to estimate its pose in a map of the environment and report that post with respect to the reference frame of a map.

In some embodiments, the maps 130, 132 can be constructed using sensors. For example, 2D LiDAR, 3D LiDAR, monocular cameras, and stereographic cameras can be used to construct the map. In some embodiments, the maps can be constructed and/or updated by autonomous mobile systems using the maps during operation in the environment. In some embodiments, the maps can be CAD models of the environment, such as drawings of a facility stored in formats including DXF, AutoCAD, or any other suitable format for storing CAD models of the environment. In some embodiments, the maps can represent lanes, intersections, speed limits, and other higher-level guidance.

The operation of the first fleet 110 and the second fleet 120 may be separated into different areas. First fleet 110 may operate in a designated area 104 within facility 102. Similarly, second fleet 120 may operate in a designated area 106 within facility 102. In some embodiments, this may be different areas on the same floor. In some embodiments, different fleets may operate on different floors of a building. For example, first fleet 110 can operate on one floor of a building and second fleet 120 can operate on a second floor.

There may be an overlap area 108 between designated area 104 and designated area 106. Autonomous mobile systems 122 and 112 may both be capable of operating within the overlap area 108 to navigate and perform actions. In such instances, it may be beneficial for fleets 110 and 120 to be able to communicate with one another. For instance, fleet management system 132 may be able to communicate operational information about autonomous mobile systems 122 such as locations, orientations, velocity, footprint, and future intended movements of an autonomous mobile system from fleet 120 to fleet management 130 through a communication link 146, which can be a wired or wireless communication link. The information can then be communicated to autonomous mobile systems 112 to, for example, facilitate collision avoidance and/or path planning taking into account the locations of autonomous mobile systems on the other fleet. For example, autonomous mobile systems can use said information to avoid getting too close to other autonomous mobile systems that have a large overhanding payload to improve safety performance. Additionally, autonomous mobile systems can plan paths that avoid getting blocked by the operation of other autonomous mobile systems, thereby facilitating improved operational efficiency.

However, fleet 110 uses map 130, which may be associated with a first reference frame. Map 130 may differ from map 132 used by fleet 120 and may be associated with a different reference frame. For instance, map 130 may have a different origin point from map 132, meaning coordinates in one map do not translate directly to another map. Further, differences in coordinate axes may exist between the two maps, such as different units, datums, or rotation definitions. For example, SI unit offsets from a facility-specific datum can exist in a map. As another example, universal transverse Mercator (UTM) format may be used in one map and latitude/longitude may be used in another. Additionally, different scales may be used between the two maps, meaning one unit could translate to a different length as between maps. As another example, one map may be distorted with respect to another. This can result from, for example, sensor drift, sensor accuracy limitations, and different sensor mounting configurations. In some instances, inherent characteristics of the environment may tend towards greater distortion. For example, autonomous mobile systems can use loop closure algorithms to reduce the effects of accumulated sensor drift. However, in facilities containing certain irregular geometries, such as in L-shaped facilities, it may be difficult for autonomous mobile systems to complete full loops around the facility, or to travel in paths that allow the autonomous mobile system to return to previous locations. Thus, it may be difficult for the autonomous mobile system to correct distortions using known techniques such as loop closure. In some instances, one autonomous mobile system fleet may use one type of map, such as an occupancy grid map, while the other autonomous mobile system fleet may use an entirely different type of map representation, such as a feature-based map, that makes it difficult to translate coordinates or features in one map to another directly. In some instances, the ground that the autonomous mobile system uses may be curved or otherwise distorted while one or more of the maps assumes a flat plane.

As such, information received in one map's reference frame, such as coordinates of the location of an autonomous mobile system 122 in fleet 120, need to be translatable to another map's reference frame, i.e., into coordinates that would be understood by an autonomous mobile system 112 in fleet 110.

In some embodiments, the source map and the target map for alignment with the source map may cover substantially the same area. As previous described, maps covering the same area may still differ from one another and may need to be aligned in order to, for example, allow different fleets of autonomous mobile systems operating in the same environment to communicate their locations therebetween.

For example, map alignment can be used for transferring, at the processor, one or more semantic information from between the source map and the target map based on the aligned map. The semantic information can include, but is not limited to, navigable space definitions, restricted zones, docking locations, and parking areas. As an example, a first map may have data about an area that is not present on a second map, such as in the case when a new fleet of robots is deployed to an area where an existing fleet has operated. This information can include definitions, semantic zones, metadata, annotations, and other data that has been configured on the first map. This configuration may have involved manual configuration by a human user. This information may need to be transferred from the first map to the second map. However, if the two maps are not aligned, transferring this data may be difficult, and may require manual intervention or repetition of effort. This may particularly be the case if one map is distorted with respect to the other. Accordingly, by aligning the two maps, the transfer of such information can be simplified.

In the case of multiple fleets operating on different floors, alignment between maps representing each floor can allow additional information, such as floor, height, and location of elevators, to be added to the maps. This can allow autonomous mobile systems from one floor to navigate to another. It can be appreciated that multiple floors can be represented in maps in three dimensions, as a series of maps with a distance offset, and/or as a series of maps with real or integer identifiers.

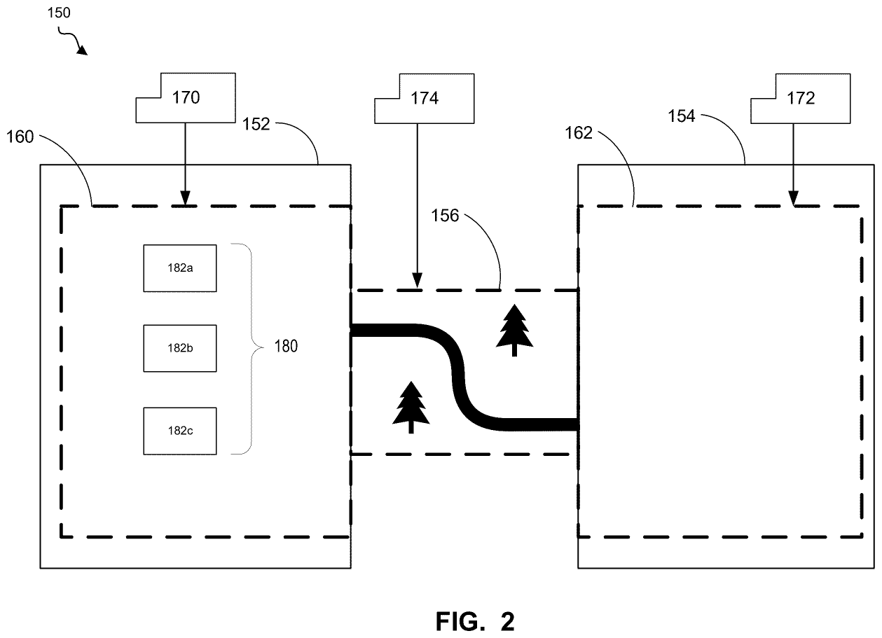

Reference is next made to FIG. 2, which shows another example scenario 150 in which systems and methods for map alignment may be used. A facility 152 may have operating therewithin a fleet 180 of autonomous mobile systems 182. Fleet 180 may be configured to use a first map 170 that represents a particular area 160, which may be limited to the area of facility 152. A second map 172 may represent a second area 162 within a second facility 154. Maps 170 and 172 can be any kind of map for use in robotic navigation, such as an occupancy grid map. Second facility 154 may be connected to facility 152 through an external area 156. External area 156 may be represented by a map 174. Map 174 may be stored in a map format suitable for exterior navigation, such as a Geographic Information System (GIS) Data based map.

One of the autonomous mobile system 182 operating in the first facility 152 may be instructed to navigate to the second facility 154. For example, a fleet management system may give the autonomous mobile system instructions to navigate to a destination located in second facility 154. In order to navigate to second facility 154, autonomous mobile system 182 may need to travel through environment 156. In order to navigate in exterior environment 156, autonomous mobile system 182 may need to use map 174. Thus, map alignment should be performed between maps 170 and 174 to allow smooth transition between map 170 and 174 when autonomous mobile system 182 navigates between environments 152 and 156.

Similarly, map 172 may need to be aligned with respect to map 174 in order to allow autonomous mobile system 182 to smoothly transition between navigating in environment 174 to facility 172. Additionally, map 172 needs to be aligned with map 170 so that autonomous mobile system 182 can (a) properly receive an instruction to navigate to facility 154 and (b) transition between using map 170 and 174 to map 172 to navigation within facility 154. Accordingly, it can be seen that it may be beneficial to align maps 170, 172, and 174 with respect to a common reference frame.

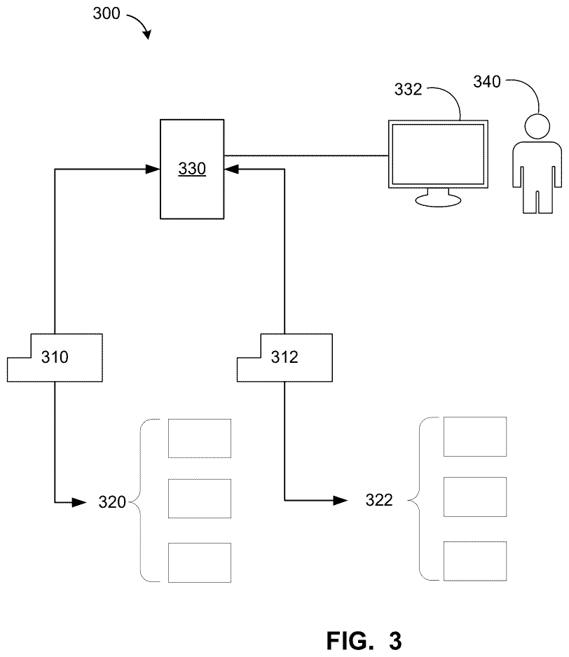

Reference is next made to FIG. 3, which shows an example system 300 for automatically aligning a source electronic map with a target electronic map to facilitate navigation by one or more autonomous mobile systems with an environment. System 300 may be used to perform map alignment between a source electronic map 310 and a target electronic map 312. The source electronic map 310 may differ from the target electronic map 312 in a number of ways. For example, the source electronic map 310 may be a map used by one fleet of autonomous mobile systems 320, while the target electronic map may be a map used by another fleet of autonomous mobile systems 322. Fleets 320 and 322 may cover different areas of a facility, such as in the case of a large facility containing multiple autonomous mobile systems, in which case the source map 310 and target map 312 may cover different spatial regions. Alternatively, the source map 310 and target map 312 can cover the same region, such as when multiple fleets from different vendors are deployed in the same area.

Maps 310, 312 can be represented in any format suitable for navigation use by autonomous mobile systems 320, such as occupancy-grid based maps, point-cloud maps, feature based maps, hybrid maps, and any other format as would be appreciated by a person of skill in the art. Source map 310 may use a different map representation from target map 312. For example, fleet 320 may use an occupancy-grid based map, while fleet 322 uses a point-cloud-based map.

In some embodiments, the source map 310 can be produced using a first sensing modality and the target map 312 can be produced using a second sensing modality, the first sensing modality being different from the second sensing modality. The sensing modalities can include any modality commonly used by autonomous mobile system to produce maps, including, but limited to, 2D LiDAR, 3D LiDAR, monocular camera, stereo cameras, radar, GPS, ultrasound, or any other suitable modality. For example, map 310 may be produced by an autonomous mobile system configured to use 2D LiDAR to produce occupancy grid maps, and map 310 may be an OGM. Map 312 may be produced by an autonomous mobile system configured to use 3D LiDAR, thus generating point cloud maps, and map 312 may be a point cloud map.

In some embodiments, the source map 310 may be an indoor map and the target map 312 may be an outdoor map (or vice versa). For example, map 310 may be produced by an autonomous mobile system using LiDAR sensors to map its environment, and map 310 may be an occupancy grid or point cloud map. Map 312 can be a GIS-based map generated using satellite imagery and created by an external map system. For example, map 310 could be map 170 of FIG. 2 and map 312 could be map 174.

A computing device 330 may be configured to determine a transformation between the source map and the target map in order to convert the reference frame of one map into the reference frame of the other map. Maps 310 and 312 can be provided to computing device 330 through a network, through a communication link, or through any method of transferring the files associated with maps 310 and 312. In some embodiments, maps 310 and 312 may already be stored on computing device 330. For example, computing device 330 can be implemented in a central server that stores maps 310 and 312. In some embodiments, computing device 330 may receive one or more of the maps 310 and 312 from another device. For example, computing device 330 may be connected, through a network connection, to one or more fleet management systems that are using maps 310 and 312 and may be configured to communicate with the fleet management systems to receive maps 310 and 312 therefrom.

A user interface device 332 may be connected to computing device 330 to produce visual outputs and to receive manual input. For example, a computer monitor, keyboard, and mouse may be used by a human user 340 to visualize the maps 310 and 312 during map alignment. The human user 340 may additionally provide input through user interface device 332 to provide input, such as reference point sets, to the device 332. Device 332 can include any one or more devices capable of visualizing outputs from device 330 and receiving human input from user 340, including, but not limited to, mobile tablets, mobile phones, mice, keyboard, remote, monitors, human-machine interfaces and any other suitable device or combination of devices.

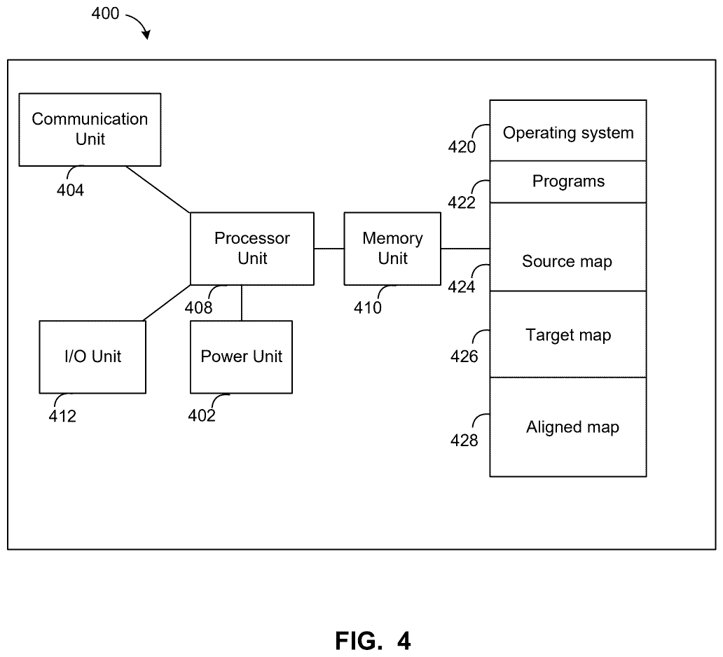

Reference is next made to FIG. 4, which shows a schematic diagram of an example computing device 400 that can be used as a computing device 330 in system 300.

Computing device 400 includes a power unit 402, communication unit 404, processor unit 408, I/O unit 412, and memory unit 410. Memory unit 410 may have stored upon it operating system 420, programs 422, source map 424, target map 426, and one or more aligned maps 428.

Computing device 400 can be any computing device, including a server, personal computer, laptop computer, mobile phone, tablet, or any such similar type of device. For example, computing device 102 can be a central computer or server connected to multiple fleet management systems maintaining maps for operating fleets of autonomous mobile systems.

The communication unit 404 may facilitate communication between the computing device 400 external devices. For example, communication unit 404 may be a network adapter such as an Ethernet or 802.11x adapter.

The processor unit 408 may include a standard processor, such as the Intel Xeon processor, for example. Alternatively, there may be a plurality of processors that are used by the processor unit 408 and may function in parallel. Alternatively, there may be a plurality of processors including a Central Processing Unit (CPU) and a Graphics Processing Unit (GPU). The GPU may be, for example, from the GeForce® family of GPUs from Nvidia®, or the Radeon® family of GPUs from AMD®. There may be a plurality of CPUs and a plurality of GPUs.

I/O unit 412 can include hardware for interfacing the computing device 400 with input and output devices, such as hardware and connectors for connecting input and output devices like mice, keyboards, monitors, audio, etc.

The power unit 416 provides power to the computing device 400 and various components thereof. Power unit 416 can be any power supply for supplying power to the computing device.

Memory unit 410 may store data required for operation of computing device 400 and can include any one or a combination of memory devices capable of storing data in a temporary or persistent manner. Memory 410 can include, for example, RAM, hard drives, solid state drives, flash memory, or a combination thereof.

The programs 222 comprise machine code that, when executed, configures the processor unit 408 to operate in a particular manner to implement various functions and tools for the computing device 400.

Operating system 220 can be any software for operating the computing device 102. Operating system 220 can be configured to interface between software and hardware components, manage software and hardware resources, and provide common services for computer programs. Operating system 220 can include any operating system as is known in the art compatible with processing device 102, such as Linux, Android, macOS, Windows, and more.

Programs 422 may include computer readable instructions for performing a variety of computational tasks on computing device 400.

Source map 424 may be stored as computer data on memory 410. Target map 426 may also be stored as computer data on memory 410. Source map 424 and target map 426 may be read and retrieved by processor unit 408 for the purposes of performing various processing and analysis steps to align target map 426 with source map 424 as will be described herein.

Aligned map 428 may be an end result of the alignment process performed by system 300. Aligned map 428 can be saved onto memory 410 for later retrieval when aligned map 428 needs to be used. Alternatively or additionally, aligned map 428 can be distributed to other devices upon creation for immediate availability.

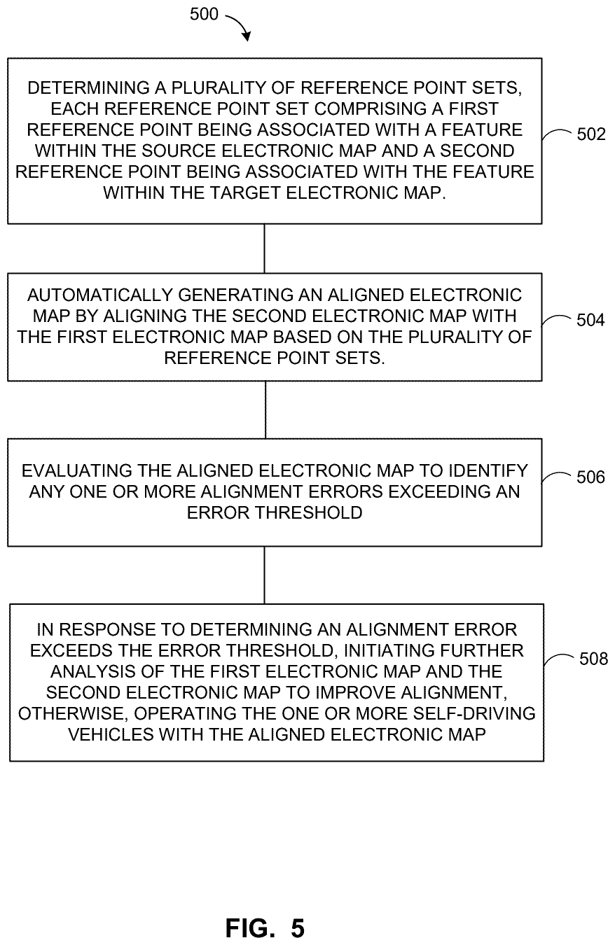

Reference is next made to FIG. 5, which shows a flowchart of an example method 500 for automatically aligning a source electronic map with a target electronic map different from the source electronic map to facilitate navigation by one or more autonomous mobile systems within an environment. Method 500 may be implemented on system 300. For example, computing device 330 may be configured to execute software code on a processing device (e.g., processing device 408) to implement one or more steps of method 500.

The method begins, at 502, with determining a plurality of reference point sets, each reference point set comprising a first reference point being associated with a feature within the source electronic map and a second reference point being associated with the feature within the target electronic map. For example, the source electronic map can be source map 310 and the target electronic map can be target map 312. A reference point can include any point on a map corresponding to a location on the map. The reference point may be selected for the purposes of aligning a point on a map with a corresponding point on another map. A reference point set includes a first reference point associated with a first map and a second reference point corresponding to the first reference point associated with a second map. The first and second reference points may correspond to the same location, physical object, or feature within their respective maps.

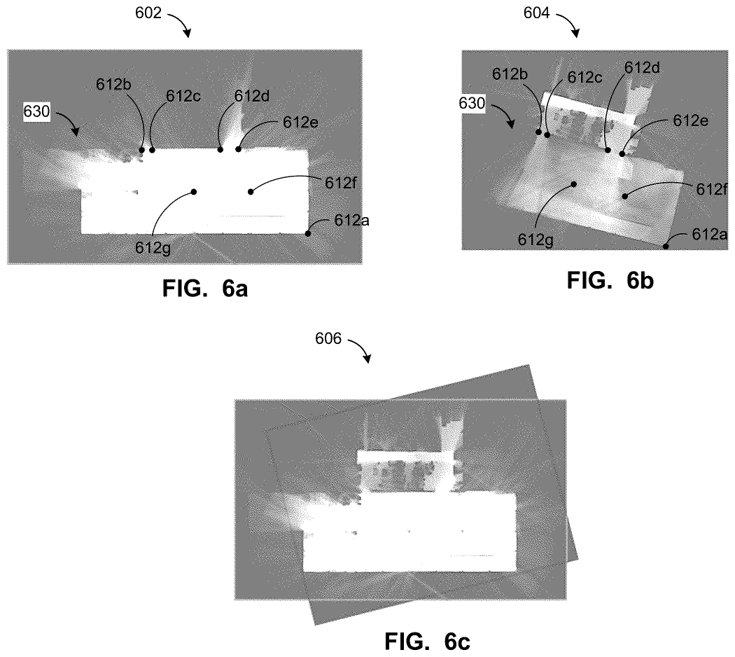

Reference is made to FIGS. 6a and 6b, which shows an example source map 602 and an example target map 604. Map 602 may be a first map used by, for example, a first fleet of autonomous mobile systems. Map 604 may be a map used by, for example, a second fleet of autonomous mobile systems. Map 604 may need to be aligned with map 602. As shown, 604 is misaligned with respect to map 602 by at least a rotation. Thus, coordinates provided in the frame of reference of map 604 cannot be directed used by an autonomous mobile system navigating using map 602 without aligning maps 602 and 604. A plurality of example reference points 610 are shown on source map 602. A plurality of corresponding reference points 612 are similarly shown on target map 604. It should be noted that map 604 can be designated as the source map and map 602 the target map, with little difference to the operation of the method other than the selection of which map is transformed.

In some embodiments, the reference points can be selected based on features of the environment. The features can be notable features in the environment such as a geometric shape, a column, a doorway, or can be any point selected based on a known location used for calibration. For example, as shown, reference points 610a and 612a are selected at a corner of the building 630. Additionally, reference points 610b, 610c, 610d, and 610e are located at doorways or entranceways of building 630.

Determining a plurality of reference point sets can be performed automatically or manually. For example, the reference points can be specified manually by a human. As an example, the computing device 330 can generate a graphical user interface containing a visualization of map 310 and 312 for presentation on user interface device 332 to human user 340. A human user 340 can provide user inputs to computing device 330 through user interface device 332 indicating the location of the reference points. For example, the human user 340 can specify a plurality of first input reference points on a visualization of the first map to specify a first set of reference points, and provide a plurality of second reference points on a visualization of the second map to specify a corresponding second set of reference points. The user can specify the correspondence between the specified reference points to form a plurality of reference point sets. In some embodiments, the visualizations of each map can differ significantly, as the maps may be in different formats. For example, one map may be displayed as a 2D LiDAR created OGM, and another map may be shown as a map of visual-features.

In some embodiments, establishing the plurality of reference point sets can be done automatically. For example, the method can include automatically detecting, at the processor, one or more first identifying features in the first map and one or more second identifying features in the second map and matching, at the processor, the one or more first identifying features to the one or more second identifying features. The identifying features can include any identifying feature as may be detectable using automated algorithms, such as, but not limited to, a corner, a landmark, and a fiducial marker.

For example, corners or other salient features can be detected in maps using corner detection algorithms. A variety of algorithms can be used for this purpose, depending on the map representation. For example, image-based algorithms such as Harris Corner Detector can be used for OGMs. A corner can be detected in a map and matched with similar corners in a second map, thereby resulting in reference point sets created at those corners.

As another example, fiducial markers may be set up across the facility. A fiducial marker can include any object detectable by an autonomous mobile system that can carry information about its identity and location. The fiducial marker can carry information about its identity, location, and pose, to allow the autonomous mobile system to localize itself with respect to the fiducial marker. For example, visual, infrared, and/or RFID tags can be placed at specific known locations. As an example, a fiducial marker could be a QR code that is installed on walls that can be scanned by autonomous mobile systems. The autonomous mobile system can then tag the location of the fiducial marker as it builds or updates a map it is using.

In some embodiments, external localization systems can be used to generate automatic reference point sets. For example, global navigation satellite systems, such as GPS, can be used. A GPS, or any other determination of position created using an external localization system such as a surveying station, can be used to determine reference points. For example, an autonomous mobile system may be configured to navigate outdoors, such as in the case shown in FIG. 2. The autonomous mobile system may be equipped with GPS capabilities and may be configured to generate GPS fixes as it moves around its environment. The autonomous mobile system can then record the GPS fixes onto a map as it moves, thereby associating certain locations on a map with the GPS fix. Alternatively, a separate device equipped with GPS capabilities and a tracking system can be used to obtain GPS fixes and obtain the relative pose of a robot or a reference point on a map. By obtaining multiple poses, reference points can be obtained that can be used to align the map. The map can be aligned with respect to another map, such as between maps 170 and 172 in FIG. 2. Alternatively, one or more of maps 170 and 172 can be aligned with respect to a global common frame of reference. For example, any suitable global frame of reference such as the Earth-centered, Earth-fixed (ECEF) coordinate system or the Universal Transverse Mercator (UTM) frame can be used.

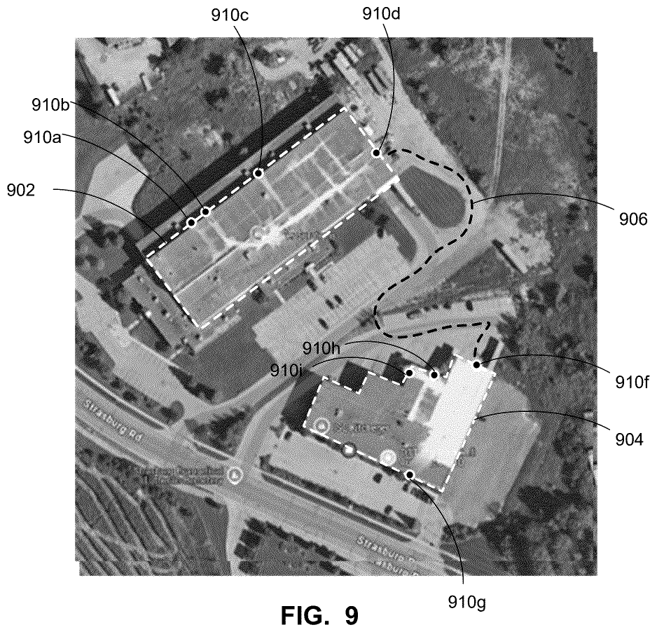

For example, FIG. 9 shows an example facility 902 and example 904 not connected by indoor spaces. An autonomous mobile system navigating between facility 902 and 904 may be required to travel through an outdoor environment along path 906. In such an example, maps for facilities 902 and 904 can be aligned to each other or with respect to a common reference frame using GPS fixes. GPS fixes 910a-910d are shown at facility 902, and GPS fixes 910f-910i are shown at facility 904. Maps representing both facilities 902 and 904 can then be automatically aligned with respect to a global coordinate system such as ECEF and UTM using the GPS fixes, thus facilitation the travel of an autonomous mobile system from one facility, through an outdoor environment, and to another facility operating using a different map.

Automatically identified reference points present in both maps can also have their correspondences automatically generated. For example, fiducial markers present in both maps can be tied to a specific identifier. When one fiducial marker is found on one map, the corresponding fiducial marker reference point can be located on the other map by searching for that specific identifier.

In some embodiments, a human user can calibrate the automatically detected reference point sets after generation to fine tune the automated placement. For example, the human user can use a graphical user interface to move any one or more of the placed reference points to a desired location.

The method proceeds, at 504, with automatically generating an aligned electronic map by aligning the target electronic map with the source electronic map based on the plurality of reference point sets. The aligning the maps may involve determining a first transformation for the target electronic map based on one or more of the plurality of the reference point sets and generating the first aligned electronic map from the target map based on the first transformation. For example, computing device 330 may generate an aligned map 428 to be stored in memory based on the source map and the target map.

The first transformation can be a rigid transformation, such as one of a rotation, translation, and scaling. For example, with reference to FIGS. 6a, 6b, and 6c, a rotation can be applied to target map 604 to align target map 604 with source map 602. Map 606 can be generated as a result of applying the transformation to map 604. Map 606 is shown in FIG. 6c overlaid on source map 602.

In some embodiments, the first transformation may be a linear transformation. For example, the alignment system may be configured to try a linear transformation first, and then use non-linear transformations only if the linear transformation does not successfully produce an aligned map.

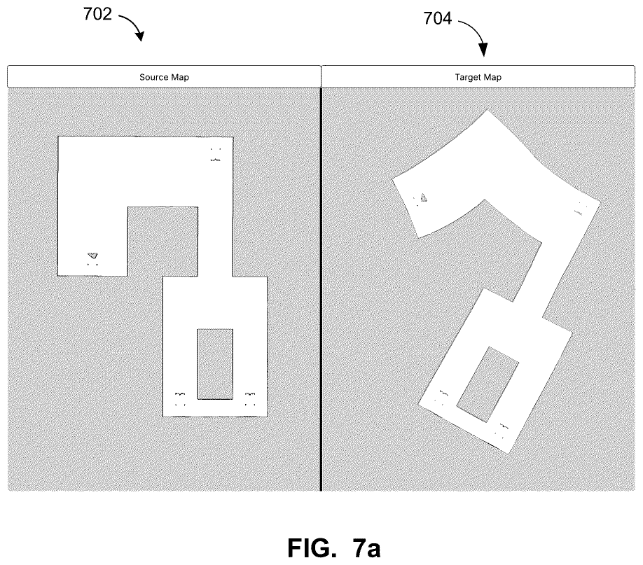

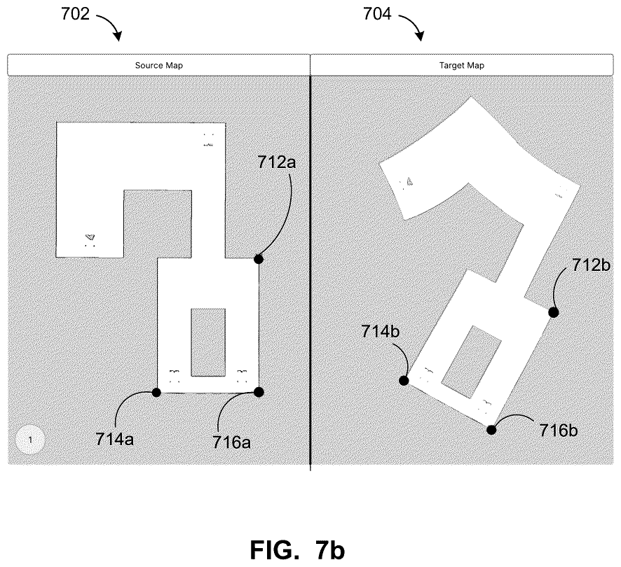

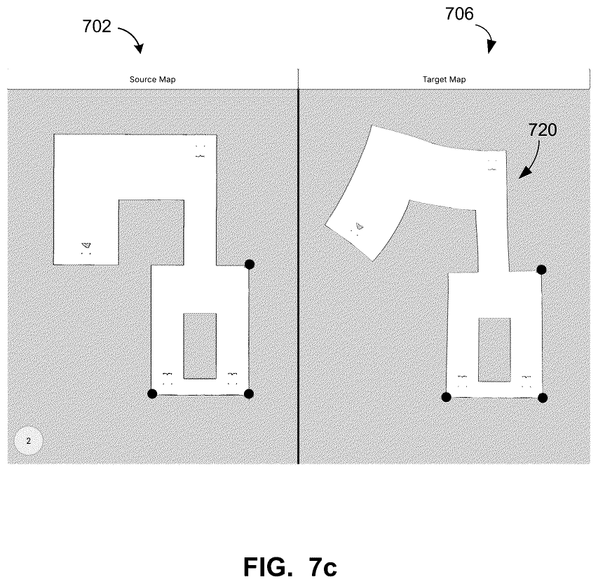

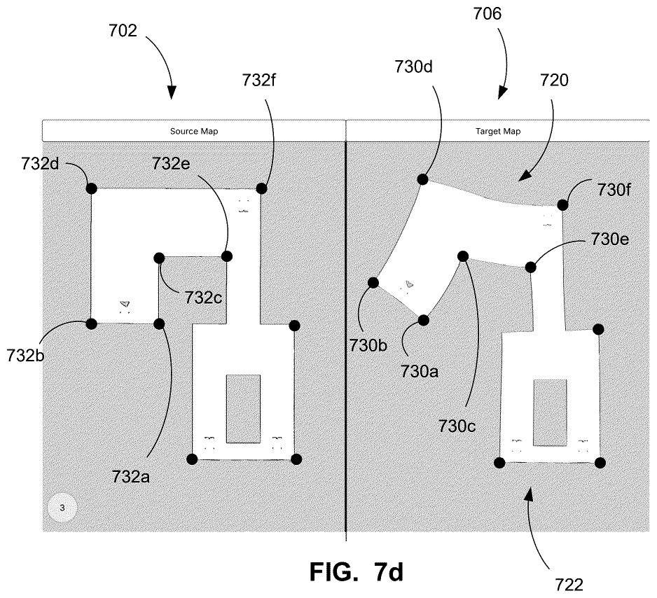

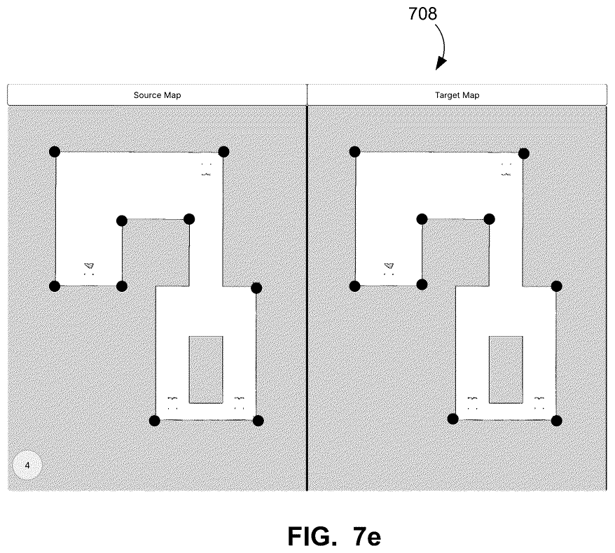

Referring to FIGS. 7a, 7b, and 7c, a source map 702 and target map 704 for alignment with the source map 702 are shown. Reference point sets 712, 714, and 716 are defined on maps 702 and 704. The reference point sets are shown located on corners of the setting represented on maps 702 704. Based on these reference points, a linear transformation (e.g., a rotation) may be identified to transform points 712b, 714b, and 716b to align with points 712a, 714a, and 716a. A first aligned map 706 is generated based on the linear transformation. As shown, first aligned map 706 is aligned with respect to the position of reference points 712, 714, and 716.

The method proceeds, at 506, with evaluating the aligned electronic map to identify any one or more alignment errors exceeding an error threshold. Evaluating the electronic map can include calculating one or more metrics of map alignment.

In some embodiments, the metric of map alignment can include an image similarity metric comparing at least one probability-based value between the maps can be used. Any means of comparing map similarity for the respective map representation as known in the art may be used. For example, for OGMs, an image similarity value based on a distance-map approach, as described by Birk et al. (A. Birk, S. Carpin, “Merging Occupancy Grid Maps From Multiple Robots”, Proceedings of the IEEE 94(7): 1384-1397, August 2006) can be used. As another example, a structural similarity index as described by Wang et al. (Z. Wang, A. C. Bovik, H. R. Sheikh and E. P. Simoncelli, “Image quality assessment: From error visibility to structural similarity,” IEEE Transactions on Image Processing, vol. 13, no. 4, pp. 600-612, April 2004.) can be used.

For point clouds maps, including maps created with feature-based visual simultaneous localization and mapping, example map alignment metrics can include determining mean-squared error between point clouds, determining Hausdorff distances between point clouds, computing fast point feature histogram (FPFH) descriptors and measuring similarity between the descriptors, computing root mean square error to compute average distance between closest points between point clouds, signed distance function approaches involving computing the signed distance for each point in one cloud to a surface defined by another cloud, and any other suitable metric as may be known to a person of skill in the art.

In some embodiments, hybrid approaches to evaluating similarity may be used. For example, an OGM can be converted into a 2D point cloud with the occupied cells above a threshold and a distance between the point clouds may be computed using the point-cloud based approaches. It will be appreciated that a number of equally viable approaches may be available depending on the specific map representation used for each map, as long as the approach can quantify the quality of alignment between two maps.

The method proceeds, at 508, with determining whether an alignment error exceeds the error threshold. The error threshold may be set based on an acceptable level of alignment. The error threshold may vary depending on the alignment metric used. The error threshold may also vary depending on the application of the map. In some embodiments, the error threshold may vary in different areas of a map. For example, in areas where autonomous mobile systems do not operate, a larger error can be acceptable. However, in areas that are heavily trafficked, such as docking stations, more accurate localization may be required, and thus, a smaller error threshold may be set.

If the determined alignment error does not exceed an error threshold, the aligned electronic map may be stored for use in operating the one or more autonomous mobile systems. The one or more autonomous mobile systems may have been initially configured to use the source map, and may be able to use the aligned map after the completion of the alignment process. For example, the one or more autonomous mobile systems may now be able to use the aligned map for navigation and localization in the areas covered by the aligned map. The aligned electronic map may be stored in the computing system used to align the map or at a different location. For example, the aligned electronic map may be provided to a fleet management system for navigation use by autonomous mobile systems controlled by the fleet management system.

FIG. 6c shows an aligned map 606 that may be substantially aligned with respect to a source map 602. As such, the alignment error between aligned map 606 and source map 602 may be within the error threshold. As such, aligned map 606 may be stored for usage in operating an autonomous mobile system.

If the alignment error exceeds the error threshold, the method proceeds with initiating further analysis of the source electronic map and the target electronic map to improve alignment. For example, referring to FIG. 7c, first aligned map 706, when evaluated for alignment relative to map 702, may have an alignment error exceeding the error threshold, as a significant amount of distortion is still present in area 720. Thus, a further analysis may be performed to improve alignment.

The further analysis of the first electronic map and the second electronic map to improve alignment can include determining a plurality of refinement reference point sets, determining a second transformation for the target electronic map based on the plurality of reference point sets and the plurality of refinement reference point sets, wherein the second transformation comprises a non-linear transformation, and generating a second aligned electronic map from the aligned electronic map based on the second transformation.

For example, if the alignment error exceeds a threshold, the alignment system can prompt a user to input a plurality refinement reference point sets and determine a second transformation based thereon. For example, a human user 340 can be presented with a prompt on user interface device 332 to input further reference point sets. One or more further transformations can then be performed based on the newly provided reference point sets to improve alignment.

In some embodiments, alignment may be evaluated for specific portions of the map, and the system can prompt the user to improve alignment in areas identified as poorly aligned. For example, a prompt can be presented to user 340 to specifically provide additional reference point sets specifically in the poorly aligned areas. The human user 340 can then provide additional reference point sets to improve alignment for the areas in question.

For example, referring to FIG. 7d, refinement reference points 730a-730f may be defined for the first aligned map 706 and refinement reference points 732a-732f corresponding to refinement reference points 732a-732f may be defined on the source map 702. Correspondences between the points may be defined by a user or through automatic means. For example, point 730a and point 732a can be corresponded to form a reference point set. Additionally, reference point sets may be formed between point 730b and point 732b, point 730c and point 732c, and so on. A second transformation may be determined based on the addition of the refinement reference points. The second transformation may be a non-linear transformation. For example, as shown in the example of FIG. 7d, it can be seen that it would be impossible for any rigid transformation to align all of the reference point sets on map 702 and map 706. Accordingly, a non-linear transformation may be required to align the reference points on maps 702 and 706.

The non-linear transformation can be any transformation that allows different transformation to be performed at different coordinates on the map. The non-linear transformation may be required to correct areas of a map with significant distortion. For example, as can be seen in FIG. 7d, differing levels of transformation may be required at the more distorted top portion 720 of map 706 than lower portion 722, which is already substantially in alignment.

In some embodiments, generating the second aligned map can include determining a plurality of weights from the plurality of reference point sets and generating, at the processor, a weighted average transformation based on the plurality of weights, wherein the plurality of weights are determined based on a proximity to the plurality of reference point sets. For example, the non-linear transformation can include one or more of a bilinear interpolation, cubic interpolation, trilinear interpolation, and cubic b-spline interpolation. Accordingly, the transformation at any target point may depend on a proximity of the point to all or a set of nearby reference points. The contribution of all reference points may be combined and weighted by a distance of each respective reference point to the target point. Each point on the target map, such as first aligned map 706, may be transformed in accordance with the non-linear transformation to produce a second aligned map. For example, referring to FIG. 7e, map 708 may be produced as a result of applying a non-linear transformation to map 706 based on the previous reference points 712a, 712b, 714a, 714b, 716a, 716, and the newly added reference points 730a-f and 732a-f. It will be appreciated that the non-linear transformation at any given point of interest may depend on that point of interest's proximity to other reference points as well as the transformation at said reference points.

The resulting second aligned map may be evaluated for alignment with respect to the source map. If sufficiently aligned, the second aligned map may be stored for navigational and localization uses by one or more autonomous mobile systems. If the alignment error of the second aligned map with respect to the source map exceeds the threshold, the above process may be repeated. For example, further reference points may be defined on the maps (and specifically, at misaligned portions of the map). Additional further transformations may be generated based thereon, and further aligned maps may be created. It will be appreciated that these steps can be repeated as many times as is necessary to bring the alignment error to within an acceptable threshold.

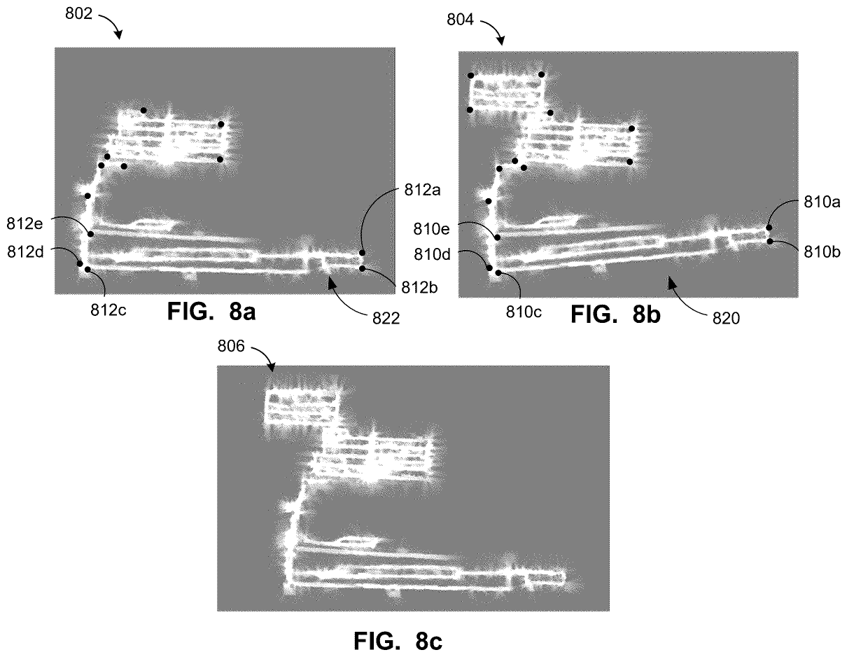

FIGS. 8a, 8b, and 8c show an example source map 802, target map 804, and a resulting aligned map 806 produced using a non-linear transformation. As shown, area 820 on target map 804 is distorted with respect to analogous area 822 on source map 802 depicting the same geographical region. A non-linear transformation using reference points 810a-810e located at region 820, corresponding to reference points 812a-812e at region 822 may be performed to generate a resulting aligned map 806.

Unless the context requires otherwise, throughout the specification and claims which follow, the word “comprise” and variations thereof, such as, “comprises” and “comprising” are to be construed in an open, inclusive sense, that is, as “including, but not limited to.” It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies. In addition, as used herein, the wording “and/or” is intended to represent an inclusive or. That is, “X and/or Y” is intended to mean X or Y or both, for example. As a further example, “X, Y, and/or Z” is intended to mean X or Y or Z or any combination thereof. It should be noted that the term “coupled” used herein indicates that two elements can be directly coupled to one another or coupled to one another through one or more intermediate elements.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

It should also be noted that there may be some elements that are used to implement at least part of one of the embodiments described herein that may be implemented via software that is written in a high-level computer programming language such as one that employs an object-oriented paradigm. Accordingly, the program code may be written in Java, C++ or any other suitable programming language and may include modules or classes, as is known to those skilled in object-oriented programming. Alternatively, or in addition thereto, some of these elements implemented via software may be written in assembly language, machine language or firmware as needed. In either case, the language may be a compiled or interpreted language.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail since these are known to those skilled in the art. Furthermore, it should be noted that this description is not intended to limit the scope of the embodiments described herein, but rather as describing exemplary implementations. Various modification and variations may be made to these example embodiments without departing from the spirit and scope of the invention, which is limited only by the appended claims.

1. A method for automatically aligning a source electronic map with a target electronic map different from the source electronic map to facilitate navigation and localization by one or more autonomous mobile systems within an environment, the method comprising:
receiving the source electronic map provided by a first fleet of autonomous mobile systems in a first modality format, the first fleet of autonomous mobile systems comprising at least one autonomous mobile system configured for a first operational goal within the environment that is suitable with the first modality format of the source electronic map;
receiving the target electronic map provided by a second fleet of autonomous mobile systems in a second modality format, the second modality format being different than the first modality format, and the second fleet of autonomous mobile systems comprising at least one autonomous mobile system configured for a second operational goal within the environment, the second operational goal being different from the first operational goal, and the second operational goal is incompatible to be performed relative to the first modality format;
determining a plurality of reference point sets within each of the source electronic map and the target electronic map, each reference point set comprising a pair of reference points having a first reference point associated with a feature within the source electronic map and a second reference point associated with the feature within the target electronic map;
determining a set of linear transformations based on the plurality of reference point sets for aligning the source electronic map in the first modality format with the target electronic map in the second modality format;
automatically generating an aligned electronic map by aligning the target electronic map with the source electronic map based on the plurality of reference point sets and the set of linear transformations;
evaluating the aligned electronic map to identify any one or more alignment errors exceeding an error threshold; and
in response to determining an alignment error exceeds the error threshold, initiating further analysis of the source electronic map and the target electronic map to improve alignment, wherein the further analysis comprises:
identifying a plurality of refinement reference point sets within each of the source electronic map and the target electronic map to improve alignment between the source electronic map and the target electronic map;
determining a set of refinement transformations for aligning the source electronic map and the target electronic map with reference to the plurality of refinement reference point sets, the set of refinement transformations comprising at least one non-linear transformation; and
updating the aligned electronic map with the set of refinement transformations;
otherwise, storing the aligned electronic map for use in operating the one or more autonomous mobile systems.

2. The method of claim 1, wherein determining the set of linear transformations based on the plurality of reference point sets for aligning the source electronic map in the first modality format with the target electronic map in the second modality format further comprises:
determining a first transformation for the target electronic map based on one or more of the plurality of the reference point sets; and
generating the first aligned electronic map from the target map based on the first transformation.

3. (canceled)

4. The method of claim 1, wherein the generating the second aligned electronic map based on the second transformation comprises:
determining, at the processor, a plurality of weights from the plurality of reference point sets; and
generating, at the processor, a weighted average transformation based on the plurality of weights,
wherein the plurality of weights are determined based on a proximity to the plurality of reference point sets.

5. The method of claim 1, wherein the establishing the plurality of reference point sets comprises:
automatically detecting, at the processor, one or more first identifying features in the first map and one or more second identifying features in the second map; and
matching, at the processor, the one or more first identifying features to the one or more second identifying features.

6. The method of claim 1, wherein the determining the plurality of reference point pairs comprises:
presenting, at a user interface, a visualization of the first map and the second map to a user; and
receiving, at the processor, one or more user inputs specifying a plurality of first input reference points on the first map and a plurality of second input reference points on the second map.

7. The method of claim 1, wherein the evaluating the aligned electronic map comprises determining an image similarity metric comparing at least one probability-based value between the maps.

8. The method of claim 1, further comprising transferring, at the processor, one or more semantic information from between the source map and the target map based on the aligned map.

9. (canceled)

10. The method of claim 1, wherein the determining that an alignment error exceeds an error threshold comprises determining that the alignment error exceeds an error threshold for a particular region of the aligned electronic map, and wherein the plurality of refinement reference point sets is located in the particular region.

11. A system for automatically aligning a source electronic map with a target electronic map different from the source electronic map to facilitate navigation and localization by one or more autonomous mobile systems within an environment, the system comprising:
a processor, configured to:
receiving the source electronic map provided by a first fleet of autonomous mobile systems in a first modality format, the first fleet of autonomous mobile systems comprising at least one autonomous mobile system configured for a first operational goal within the environment that is suitable with the first modality format of the source electronic map;
receiving the target electronic map provided by a second fleet of autonomous mobile systems in a second modality format, the second modality format being different than the first modality format, and the second fleet of autonomous mobile systems comprising at least one autonomous mobile system configured for a second operational goal within the environment, the second operational goal being different from the first operational goal, and the second operational goal is incompatible to be performed relative to the first modality format;
determine a plurality of reference point sets within each of the source electronic map and the target electronic map, each reference point set comprising a pair of reference points having a first reference point associated with a feature within the source electronic map and a second reference point associated with the feature within the target electronic map;
determine a set of linear transformations based on the plurality of reference point sets for aligning the source electronic map in the first modality format with the target electronic map in the second modality format;
automatically generate an aligned electronic map by aligning the target electronic map with the source electronic map based on the plurality of reference point sets and the set of linear transformations;
evaluate the aligned electronic map to identify any one or more alignment errors exceeding an error threshold; and
in response to determining an alignment error exceeds the error threshold, initiate further analysis of the source electronic map and the target electronic map to improve alignment, wherein the further analysis comprises:
identifying a plurality of refinement reference point sets within each of the source electronic map and the target electronic map to improve alignment between the source electronic map and the target electronic map;
determining a set of refinement transformations for aligning the source electronic map and the target electronic map with reference to the plurality of refinement reference point sets, the set of refinement transformations comprising at least one non linear transformation; and
updating the aligned electronic map with the set of refinement transformations;
otherwise, storing the aligned electronic map for use in operating the one or more autonomous mobile systems.

12. The system of claim 11, wherein the processor is further configured to:
determine a first transformation for the target electronic map based on one or more of the plurality of the reference point sets; and
generate the first aligned electronic map from the target map based on the first transformation.

13. (canceled)

14. The system of claim 11, wherein the processor generates the second aligned electronic map based on the second transformation by:
determining, at the processor, a plurality of weights from the plurality of reference point sets; and
generating, at the processor, a weighted average transformation based on the plurality of weights,
wherein the plurality of weights are determined based on a proximity to the plurality of reference point sets.

15. The system of claim 11, wherein the processor establishes the plurality of reference point sets by:
automatically detecting, at the processor, one or more first identifying features in the first map and one or more second identifying features in the second map; and
matching, at the processor, the one or more first identifying features to the one or more second identifying features.

16. The system of claim 11, wherein the processor determines the plurality of reference point pairs by:
presenting, at a user interface, a visualization of the first map and the second map to a user; and
receiving, at the processor, one or more user inputs specifying a plurality of first input reference points on the first map and a plurality of second input reference points on the second map.

17. The system of claim 11, wherein the processor evaluates the aligned electronic map by determining an image similarity metric comparing at least one probability-based value between the maps.

18. The system of claim 11, wherein the processor is further configured to transfer one or more semantic information from between the source map and the target map based on the aligned map.

19. (canceled)

20. The system of claim 11, wherein the processor determines that an alignment error exceeds an error threshold by determining that the alignment error exceeds an error threshold for a particular region of the aligned electronic map, and wherein the plurality of refinement reference point sets is located in the particular region.
